(19) United States
(12) Patent Application Publication
(10) Pub. No.: US 2026/0009880 A1
(43) Pub. Date: Jan. 8, 2026

(54) SYSTEM AND METHOD FOR LEARNED EMITTER IDENTIFICATION AND TRACKING

(71) Applicant: Raytheon Company, Tewksbury, MA (US)

(72) Inventors: Esteban Luis Valles, Los Angeles, CA (US); Andrew W. Tudor, Los Angeles, CA (US); Garry S. Oh, Santa Barbara, CA (US); Andres Ivan Vila Casado, Culver City, CA (US); Hannah McDonald, El Segundo, CA (US)

(21) Appl. No.: 18/761,955

(22) Filed: Jul. 2, 2024

(51) Int. Cl. G01S 7/28; G01S 7/02; G01S 7/41

(52) U.S. Cl. CPC G01S 7/2806; G01S 7/021; G01S 7/417

(57) ABSTRACT

A system and method are described for emitter identification and tracking in an electronic warfare (EW) environment. The system includes an antenna array configured to receive signals from radio frequency (RF) emitters during a dwell. Processing circuitry converts the received signals into digital signals. Pulses are detected and characteristics of the pulses determined to form pulse descriptor words (PDWs). The PDWs obtained during the dwell are deinterleaved using unsupervised machine learning to form clusters. The clusters are categorized using one or more supervised machine learning algorithms to determine whether the PDWs correspond to known or unknown emitters and the results tracked as in or out of library emitters. After merging the in or out of library emitters, an emitter report is generated and used to update a library of emitter profiles used by the supervised machine learning algorithms as well as determine countermeasures to generate.

### TECHNICAL FIELD

The present subject matter relates generally to electronic warfare (EW) systems and more specifically to methods and systems for identification and tracking of emitters in complex EW environments.

### BACKGROUND

EW involves the strategic use of the electromagnetic spectrum to detect, deceive, and disrupt enemy radar and communication systems while ensuring friendly use. In modern warfare, it is at a minimum useful to accurately determine whether to respond to electronic signals, particularly radar emissions, in EW environments. One challenge for a system in an EW environment is the effective identification and tracking of radar emitters, which is used for assessing threats and deploying appropriate countermeasures.

Traditional approaches to radar emitter identification have relied on predefined databases known as Mission Data Files (MDFs). These databases contain characteristics of known emitters and are used to analyze incoming radar signals to identify an emitter. However, several limitations have become apparent with this methodology, including the agility of modern radar systems, the ability to handle unknown emitters, and computational demands within the limited processing ability of the processor in the EW environment.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an electronic warfare environment according to some embodiments.

FIG. 2 illustrates a block diagram of an electronic device in accordance with some aspects.

FIG. 3 illustrates an electronic warfare system according to some embodiments.

FIG. 4 illustrates a receiver block diagram according to some embodiments.

FIG. 5 illustrates a scenario according to some embodiments.

FIG. 6 illustrates a deinterleaver process according to some embodiments.

FIG. 7 illustrates a deinterleaving output according to some embodiments.

FIG. 8 illustrates features in cluster descriptor according to some embodiments.

FIG. 9 illustrates an ensemble Prediction in accordance with some aspects.

FIG. 10 illustrates an in and out of library detector output in accordance with some aspects.

FIG. 11 illustrates an in and out of library detector process in accordance with some aspects.

FIG. 12 illustrates a time-of-arrival Correlation Basis Function example in accordance with some aspects.

FIG. 13 illustrates a method of emitter identification and tracking in accordance with some aspects.

### DETAILED DESCRIPTION

As above, MDF-only radar emitter identification suffers from a number of deficiencies. For example, new radar systems are designed to be highly agile, capable of altering their operational parameters to evade detection and jamming efforts. This agility renders static databases like MDFs less effective as they may not contain the most current emitter profiles. Moreover, the effectiveness of the identification is dependent on the MDF being comprehensive and up-to-date. Maintaining such a database is resource-intensive, requiring constant updates as new emitter types and modes are encountered. That is, multiple IF/ELSE-type statements are defined and a large number of parameters and thresholds are tuned to determine a radar type in MDF-based methods. This is hard to maintain and update once a new radar type or new radar mode is detected. In addition, MDF systems struggle with emitters that are not in the database. These ‘out-of-library’ emitters are typically flagged as unknown, which can hinder effective response strategies in dynamic combat environments. Also, the process of matching against a large database may be computationally expensive, particularly when dealing with a high volume of incoming signals in real-time scenarios. This may be problematic, especially in situations in which the processor has limited processing power. Adding a new radar to the library involves a new set of decision rules and parameter changes that affects all other radars that have been previously seen.

The system herein provides a more adaptive and intelligent system that is capable of learning from incoming data to identify and track both known and previously unknown (i.e., unseen) radar emitters. The system employs an architecture that integrates machine learning (ML) techniques to dynamically classify and track radar emitters without relying solely on traditional MDFs. This approach not only enhances the adaptability of the system to new threats but also improves the ability of the system to handle emitter agility and reduce dependency on extensive pre-existing databases.

The system described utilizes a combination of supervised and unsupervised ML algorithms to analyze pulse descriptor words (PDWs). This analysis enables the system to identify patterns and changes in emitter behavior that may not be documented in any database. This capability improves maintaining situational awareness and ensures that EW assets are accurately targeted and effective, thereby enhancing overall mission success in modern combat environments.

The system includes RF antennas and receivers configured to receive RF signals from an environment to model various aspects of the environment. The system is configured to detect and analyze pulses within received RF signals as part of the environment mapping or analysis. The analysis is used to obtain pulse parameters used to identify emitters, such as radar emitters. The system can be used in a wide variety of applications such as military, security, weather detection and forecasting, traffic enforcement, exploration, mapping, to identify the source of the pulses and determine what actions to take. In particular, a set of PDWs is determined from a digitized RF signal. The PDWs are supplied to signal processing blocks that process the pulse parameters to identify an emitter that is the most likely source of the PDWs. A library of known emitters is then updated and decision rules for future PDWs are adapted.

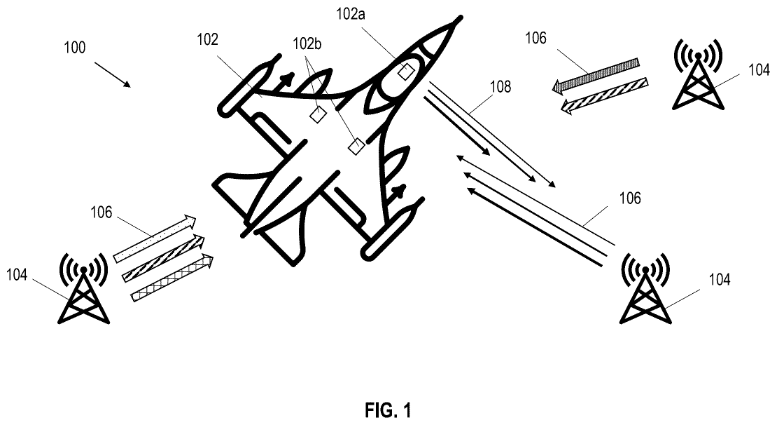

FIG. 1 illustrates an electronic warfare environment according to some embodiments. As shown, an aircraft 102 (or other military vehicle) is operational through an environment 100 that contains multiple emitters 104. Each emitter 104 may be, for example, an enemy emitter or a friendly or neutral emitter (such as a base station operated by a carrier). Each emitter 104 may emit one or more signals 106 that are received at one or more antennas (or antenna arrays) 102b of the aircraft 102. Each of the signals 106 may have different characteristics, such as center frequency, amplitude, modulation category, or pulse width. One or more processors (or processing circuitry) 102a in the aircraft 102 may determine whether or not to take countermeasures 108 in response to reception of one or more of the signals 106 from one or more of the emitters 104. The countermeasures 108 may include, for example, electronic countermeasures such as emitting jamming signals or countering signals, or taking physical action such as engaging in evasive maneuvers.

The aircraft 102 has an onboard processor 102a to detect the signals 106 received by the antennas 102b. The processor 102a performs high-speed signal analysis and threat evaluation. The processor 102a may include, for example, a general-purpose processor, a central processor unit (CPU), an Advanced Reduced Instruction Set Computer (RISC) Machine (ARM), Digital Signal Processor (DSP), Field-Programmable Gate Array (FPGA), and/or Application-Specific Integrated Circuit (ASIC) among others. The processor(s) 102a may in combination handle a wide range of tasks and support a variety of software applications for signal analysis and response management, interact with other aircraft systems and for manage user interfaces within the aircraft 102, process signal data at high speeds (including transforming and analyzing the data), and configure processing operations to adapt to new threats or changes in the signal environment, among others.

The signals 106 originate from various emitters 104. The emitters may include hostile radar installations, electronic countermeasure systems, or communication signal transmitters, each capable of emitting complex modulated signals across a wide range of frequencies and power levels. The signals may employ techniques such as frequency hopping or phase modulation to evade detection and jamming, posing a significant challenge for electronic warfare systems. The signals 106 may include radar signals and communication signals, among others. Radar Signals are typically high-frequency pulses used for detection and ranging and may vary in pulse width, repetition frequency, and modulation techniques. Radar systems may use pulse compression techniques or frequency hopping to avoid jamming and detection. Communication signals may be emitted by base stations, for example, and used by consumer or business/industrial devices.

The processor 102a in the aircraft 102 may use DSP techniques to analyze the signals 106. In general, the processor 102a may demodulate and decode the signals 106 to extract parameters such as frequency, phase, amplitude, and modulation type. The parameters may be analyzed by the processor 102a to classify the type of emitter 104 that has emitted each signal 106 and assess the potential threat the emitter 104 poses. The processor 102a may control emitters in the aircraft 102 to transmit electronic countermeasure signals in response to the analysis. The electronic countermeasure signals may be specifically designed to disrupt or deceive electronic systems and thus may include noise jamming signals, which are broad-spectrum emissions intended to mask various aircraft signals and interfere with the enemy's signal reception, or other jamming techniques like replicating or altering signals to confuse radar or communication systems (e.g., to suggest a different location or velocity of the aircraft 102) or electronic spoofing and deception techniques to mimic the characteristics of friendly or neutral entities to mislead enemy sensors.

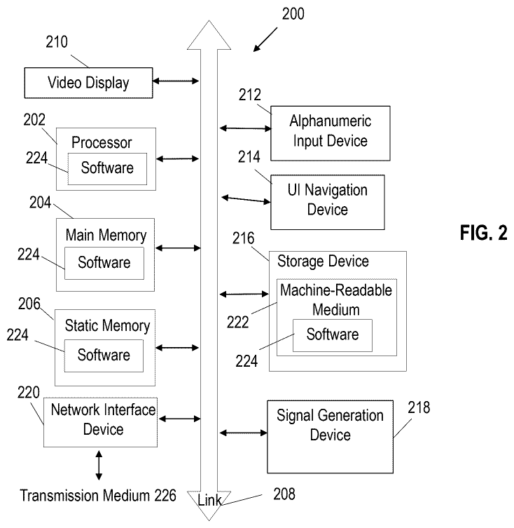

FIG. 2 illustrates a block diagram of an electronic device in accordance with some aspects. The electronic device 200 may be a specialized computer, dedicated equipment, or any machine in an EW vehicle (such as an aircraft) capable of executing instructions (sequential or otherwise) that specify actions to be taken by that machine in an EW environment. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The electronic device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The electronic device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The electronic device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The electronic device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the electronic device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the electronic device 200 and that cause the electronic device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), IEEE 202.11 family of standards, and wireless data networks. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology.

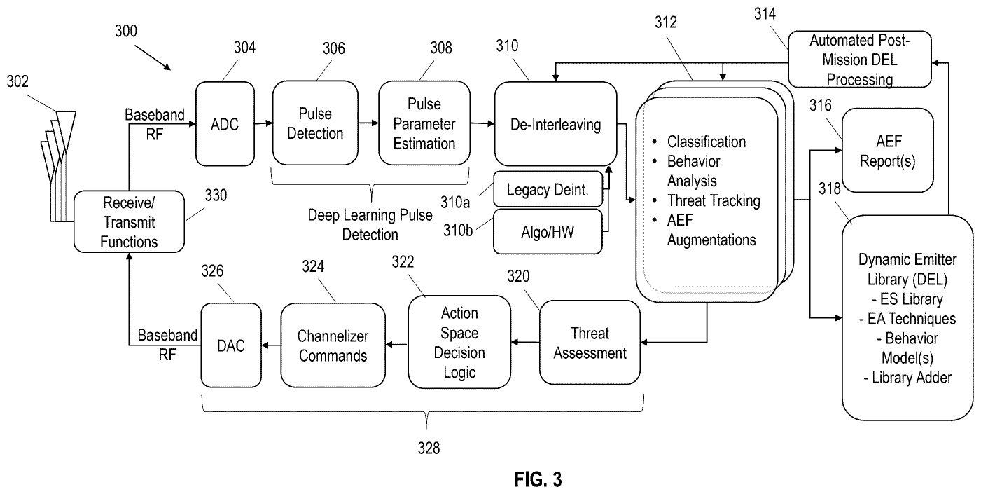

FIG. 3 illustrates an electronic warfare system according to some embodiments. The electronic warfare system 300 may be installed in the aircraft shown in FIG. 1. The electronic warfare system 300 includes one or more antennas 302 (or antenna arrays) that are configured to receive signals (i.e., waveforms) having a wide range of characteristics and from at least about a 180-degree range of reception (towards the ground). The signals are thus captured by a single or multiple set of antennas 302 at a center frequency, Fc.

Signals received by the antennas 302 may be supplied to receive/transmit circuitry 330 that provides receive/transmit functions. The receive/transmit circuitry 330 may include, for example, an RF front end that includes a circulator that permits transfer of the received signals from the antennas 302 to a receive chain of the electronic warfare system 300 or electronic countermeasure signals from a transmit chain of the electronic warfare system 300 to the antennas 302 for transmission of the electronic countermeasure signals. The receive/transmit circuitry 330 may also include one or more of amplifiers, filters, mixers, and buffers, for example. The mixers, for example, may be used to downconvert the received signals to baseband radio frequency (RF) signals, which are filtered by one or more filters to remove interference.

The analog baseband RF signals may be supplied to an analog-to-digital converter (ADC) 304. The digital signals created by the ADC 304 may be supplied to a pulse detector 306 and pulse parameter estimator 308 that estimates various parameters of the pulses from the ADC 304. The ADC 304, pulse detector 306, and pulse parameter estimator 308 may digitize the analog baseband RF signals into PDW that summarize the waveform parameters in the detected pulse. In some embodiments, a ML model may be used by the pulse detector 306 and pulse parameter estimator 308 to provide deep learning pulse detection.

In some embodiments, the pulse detector 306 may include a digital sampling circuit that converts the analog baseband RF signals to digital samples. These samples may be referred to as IQ samples since the samples can be represented as a complex number with real (I) and imaginary (Q) components. The pulse detector 306 determines which IQ samples belong to a pulse and which belong to periods of noise without pulses. In radar applications, radar signals may have large duty cycles in which pulses are only present for a fraction of the transmission time. Therefore, only retaining IQ samples from times in which pulses are present allows a reduction of samples to be processed. The pulse parameter estimator 308 may similarly be used to further reduce the representation of a pulsed waveform to a smaller number of parameters that describe the pulse as PDWs.

In particular, the environments in which the electronic warfare system 300 is used may have a number of active emitters that generate a high density of pulsed waveforms (i.e., pulses, or radar signals). As above, processing all of the pulses so generated using a power-limited embedded processor may be difficult at best. Accordingly, PDWs are used to describe the received pulses. A PDW is essentially a compact, downsampled representation of various characteristics of radar pulses. These characteristics include parameters such as pulse width, pulse repetition interval (PRI), pulse amplitude, angle of arrival, center frequency, and others depending on the specific receiver.

The output from the pulse parameter estimator 308 may be supplied to a de-interleaving module 310. The de-interleaving module 310 may include a legacy de-interleaving module 310a and a deep-shallow learning \clustering algorithm or hardware 310b to provide de-interleaving of the PDWs. The de-interleaving module 310 may process the PDWs to infer which PDWs are emitted from the same emitter shown in FIG. 1. Such inference may utilize different sensors and measurements, as described in more detail below.

The output of the de-interleaving module 310 may be supplied to a multi-mode module 312 that provides a number of different functions based on the de-interleaved PDWs. The functions may include, for example, classification, behavioral analysis, threat tracking, and AEF Augmentation. Classification may be used to infer the type and identity of a threat with different granularities (e.g., Target Engagement Radar, SA-20, Foe, Serial Number 123, . . . ). Behavioral analysis may be used to infer the operating mode of the radar and quantify any significant and/or unexpected changes in the waveform. AEF Augmentations may be used to supply downstream algorithms with new and useful information to enact Electronic Countermeasures (ECM) and supply other ML algorithms.

The output of the multi-mode module 312 is used to create an AEF report 316 and store the information from the multi-mode module 312 in a Dynamic Emitter Library (DEL) 318 onboard the aircraft. The DEL 318 may contain an electronic support(ES) library, electronic attack (EA) techniques, behavior model(s) of signals, and a library adder. Unlike an MDF, which is a database with rows of data such as Radar-A, Frequency A, PW-A, Modulation-A, the DEL 318 is a library of PDWs from different emitters used to train the ML algorithm to build a structure to determine to which class a received pulse belongs. The DEL 318 may include useful ML features and behavioral patterns that are added at inference time of the ML model. The information in the DEL 318 may be supplied to an automated emitter library update 314, which may provide automated processing to, among others, associate new emitter data with an existing emitter label, permitting re-training/updating of ML algorithms to incorporate the information so that subsequent observations of the same pattern permit correct classification. This avoids the use of a traditional MDF (or similar table) in the architecture described herein. Moreover, as the classifiers are used for training are lightweight compared to deep learning networks that use a large computer with GPUs for training, the library updates may occur during a mission. This also avoids complicated issues associated with adding new signals to the supervised library, as this process simply involves a fine tuning of supervised ML algorithms without manual parameter tuning. The output of the automated emitter library update 314 may be supplied to the multi-mode module 312 for subsequent use. The automated emitter library update 314 may be used to extract useful information in the DEL 318 to update various ML model logic. The automated emitter library update 314 may provide automated post-mission DEL processing in some embodiments.

The output of the multi-mode module 312 may also be used by a countermeasure module 328 to determine ECM priority and generate countermeasure waveform for transmission via the transmit chain. The countermeasure module 328 may include a threat assessment module 320 that determines from the multi-mode module 312 information the level of threat from the received signals, action space decision logic 322 that determines the appropriate action to take based on the threat assessment (e.g., jamming, evasion, nothing), a channelizer commands module 324 that creates the appropriate digital signals based on instructions from the action space decision logic 322, and a digital-to-analog converter (DAC) 326 that converts the PDWs from the channelizer commands module 324 to response baseband RF signals. The response baseband RF signals are supplied to the receive/transmit circuitry 330 for transmission by the antennas 302.

As above, the MDF-Free techniques described herein permit identification of the most likely source of a set of (radar-generated) RF pulses represented by pulse descriptions. The techniques combine different ML methods and synthesizes the ML methods with more traditional legacy radar detection algorithms resulting in an architecture that significantly improves the radar electronic support(ES) and radar/emitter identification performance in the presence of agile radar threats. A combination of supervised machine learning algorithms is used that target the identification of previously seen radars (i.e., known emitters), with unsupervised machine learning methods to track radars or radar modes that are unknown and have not been seen before and are not present in the training data. The techniques herein allow characterization and identification of active emitters that are being sensed by the receiver and results in a significant performance improvement in radar detection. The problem of adding new signals to the supervised library simply involves a fine tuning of the supervised algorithms and involves no manual parameter tuning, unlike MDF techniques.

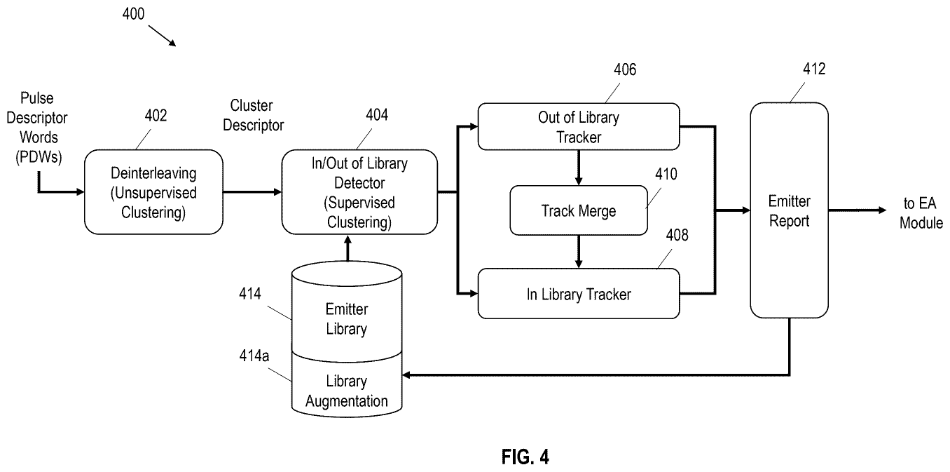

FIG. 4 illustrates a receiver block diagram according to some embodiments. The system 400 shown in FIG. 4 includes the antennas, the RF front end, digital sampler, pulse detector, and pulse parameter estimator described in relation to FIG. 3 to produce the PDWs, and provides more description of the multi-mode module of FIG. 3. As above, the PDWs may describe the RF signal properties Carrier Frequency (Fc), Pulse Amplitude (PA), Pulse Width (PW), Time of Arrival (TOA), Angle of Arrival (AOA), Pulse Repetition Interval (PRI), among others.

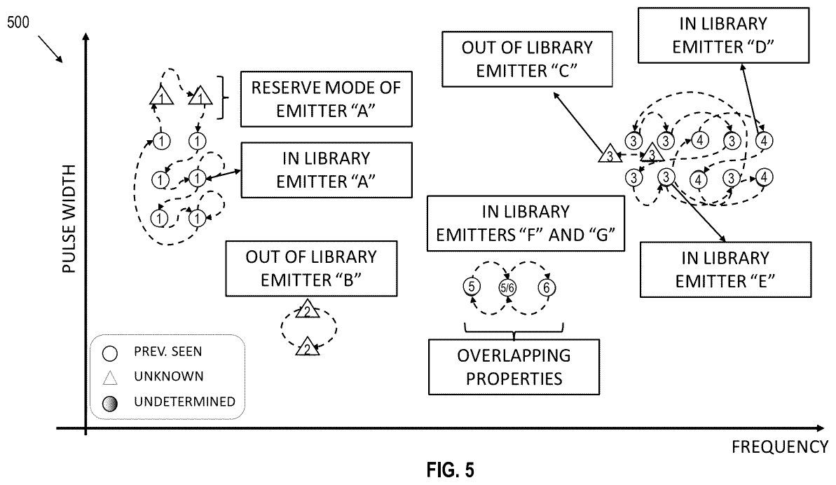

As shown, the PDWs are supplied to a deinterleaver 402, whose operations may be used to support the scenario depicted in FIG. 5. The deinterleaver 402 may use one or more unsupervised ML algorithms to analyze the PDWs. The scenario 500 in FIG. 5 is used a baseline example to describe how the different signal processing circuitry in FIG. 4 transforms signals to produce the desired outputs. As shown, Emitter “A” has some behavior that has been previously seen (circles labeled 1) and some that has not been seen (triangles labeled 1). The dotted lines between PDW pairs indicated by the circles and triangles indicate transitions of pulse parameters as a function of time. Emitter “B” is an out of library emitter that has never seen before, as evidenced by the triangles labeled 2. Emitter “C” is also out of library (triangles labeled 3) but has very similar characteristics to two in library emitters “D” and “E”, indicated by circles respectively labeled 3 and 4. Emitters “F” and “G” have been seen before. However, there are modes that have overlapping PDW properties, shown by the circles labeled 5, 5/6, and 6; that is by simply looking at the two sample intrinsic properties in the example: “frequency’ and “pulse width” there is insufficient information to determine in some cases whether a PDW has been generated by “F” or “G”. To determine the emitter class for this type of cluster, extrinsic properties based on time of arrival, signal amplitude and/or angle of arrival is used to assign a track.

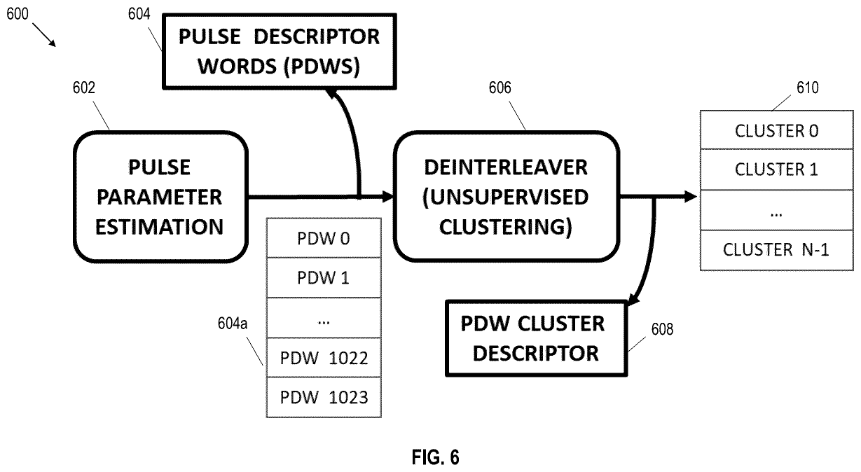

FIG. 6 illustrates a deinterleaver process according to some embodiments. The deinterleaver process 600 may include a pulse parameter estimator 602 that uses IQ samples from a pulse and produces PDWs 604 that describe those samples. Since this operation may involve fast processing, pulse parameter estimation is often implemented on firmware. Firmware refers to software that is tightly integrated with the hardware of the embedded system. Firmware controls low-level hardware functions and operations, such as signal processing, data acquisition, and interface communication with other system components. Firmware may be responsible for implementing critical timing constraints and real-time processing tasks used for radar operation, such as pulse generation, signal filtering, and modulation/demodulation. The pulse parameter estimator may reside in a field programmable gate array (FPGA).

Once the PDWs 604 are computed the PDWs may be stored in a buffer on the firmware processor. A typical size for such a buffer may be 1024 PDWs, although other sizes are possible. Once the PDW buffer 604a is complete, a flag is set to let the deinterleaver 606 know that PDWs 604 are ready to be processed. Interleaving occurs when radar pulses from multiple radar beams or channels overlap in time due to simultaneous transmission or reception. Deinterleaving refers to the process of separating and organizing interleaved radar returns represented by the PDWs 604. The PDWs 604 in the PDW buffer 604a are interleaved and thus are deinterleaved before further processing. Deinterleaving may be implemented in firmware or software, depending on the throughput desired and the complexity of the operations used for deinterleaving.

In the embodiments described herein, the deinterleaver 606 uses an unsupervised ML. The first operation in the deinterleaver 606 is to aggregate or cluster (i.e., group) multiple PDWs with similar statistical properties into clusters 610 that are indicated by a PDW cluster descriptor 608. Cluster analysis is an iterative process of knowledge discovery or interactive multi-objective optimization that involves trial and failure. Statistical quantities of the feature distribution are analyzed and used to generate tight clusters where a single mean value can represent a collection of pulses. In one embodiment, density clustering may be implemented by using a Density-Based Spatial Clustering of Applications with Noise (DBSCAN) algorithm to create clusters of PDWs based on features such as pulse width, center frequency and signal power. Features used for clustering depend on the sensors available in the radar receiver.

Density-based spatial clustering of applications with noise is a data clustering algorithm that is a density-based clustering non-parametric algorithm: given a set of points in some space, the DBSCAN algorithm groups together points that are closely packed together (points with nearby neighbors), marking as outliers points that lie alone in low-density regions (whose nearest neighbors are too far away). Other density-based methods that are similar to DBSCAN, such as Hierarchical Density-Based Spatial Clustering of Applications with Noise (HDBSCAN) may also be used. The choice of the algorithm depends on throughput and performance of the algorithm based on available features. In another embodiment, an agglomerative clustering algorithm may be used.

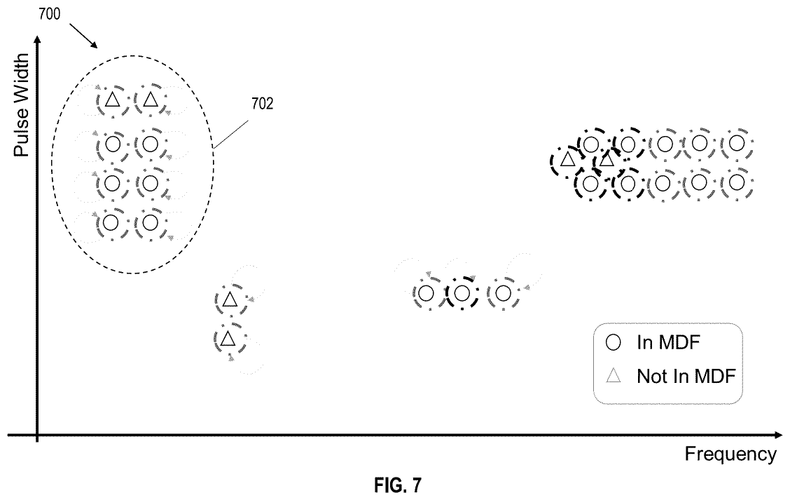

FIG. 7 illustrates a deinterleaving output according to some embodiments. That is, the output of unsupervised deinterleaving 700 for the scenario of FIG. 5 is shown in FIG. 7. Since this is an unsupervised process, no emitter ID labels are present at this stage. The clusters 702 shown in FIG. 7 are referred to as “tight clusters” as one goal is to break down and segment incoming PDWs in small clusters with homogeneous properties. Circuitry that is downstream in the overall architecture (shown in FIG. 3) may aggregate tight clusters belonging to the same class back together.

Using unsupervised clustering immediately after the PDW generation also results in a significant downsampling of the large amount of PDWs 604 present in the PDW buffer 604a so that subsequent inference algorithms only process a representative set of PDWs 604 in a cluster instead of all PDWs 604 that have been generated by the pulse parameter estimator 602. For example, a stable emitter that is not agile in frequency or pulse width and has a very high pulse repetition frequency may fill up a large portion of the PDW buffer 604a. Assume 900 entries in the PDW buffer 604a of length 1024 are coming from the same emitter source. If these 900 entries are clustered together in a single cluster, then to infer the pulse ID of the 900 pulses inference algorithms may be run on a small but representative set of PDWs 604 from the cluster 702 instead of for all 900 entries, resulting in a significant speed up.

Returning to FIG. 4, the output from the deinterleaver 402 may be supplied to an IN/OUT OF LIBRARY DETECTOR 404. In one embodiment, the mean value of the pulse features in a cluster may be used as the representative samples that are used as an input to the IN/OUT OF LIBRARY DETECTOR 404.

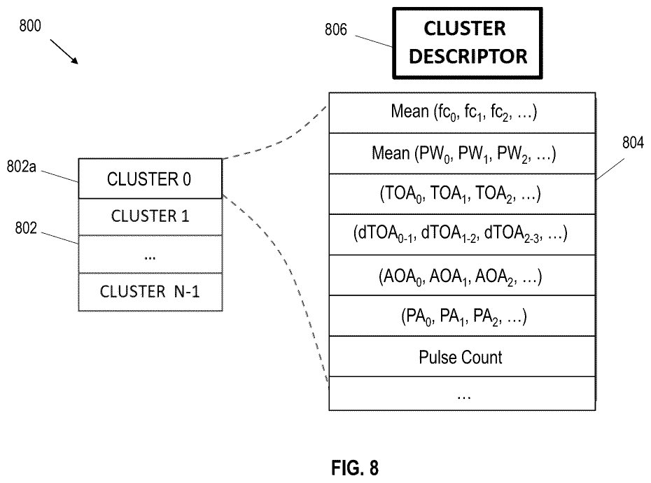

In another embodiment, a programmable random set of samples from the pulses in the cluster may be used as features in the cluster descriptor. Other cluster-specific features may be added to the cluster descriptor. Such features are shown in FIG. 8, which illustrates features in a cluster descriptor according to some embodiments. In the cluster information 800 shown in FIG. 8, the cluster buffer 802 includes multiple clusters 802a, each of which is defined by a set of cluster features 804 and indicated by a cluster descriptor 806. Some or all of the cluster features 804 may be used by the supervised classification algorithm of the IN/OUT OF LIBRARY DETECTOR 404; some or all of the cluster features 804 may be used by a cluster tracker, which may or may not be the same as the cluster features 804 used by the supervised classification algorithm. The cluster descriptor 806 is provided as an input to the IN/OUT OF LIBRARY DETECTOR 404.

In one embodiment, a Bayesian Inference Engine may be used by the IN/OUT OF LIBRARY DETECTOR 404 to determine whether a PDW being analyzed has been originated by an in-library radar source or by an unknown or out of library (OOL) source. The algorithm may be trained based on the PDWs from previously seen emitters. The PDWs may be either sampled from real warfare scenarios or simulated based on behaviors from known sources.

During operation in an EW environment (e.g., the mission), the Bayesian Inference Engine may be re-trained or fine-tuned by updating the library of known emitters to better reflect the prior probability of the EW environment. In other words, if an emitter exhibits a previously unknown mode, then the data library used for algorithm training may be expanded to include additional entries that update the prior probability of that measurement. In the scenario 500 shown in FIG. 5, the reserve modes from Emitter “A” plotted as triangles with the enumeration “1” may be added to the mission library after associating the modes with the in-library modes (plotted as circles with the enumeration “1”).

In another embodiment a Random Forest classifier may be used for supervised classification to determine whether the PDW being analyzed has been originated by an in-library radar source or by an unknown or OOL source. In other embodiments, an extension of Random Forest algorithms called Extra Trees may be used for in-library detection. In some embodiments, one or more supervised classification algorithms may be used, including Support Vector Machines (SVMs) Classifiers, Gradient Boosting, Ada Boost, Decision Trees, and others.

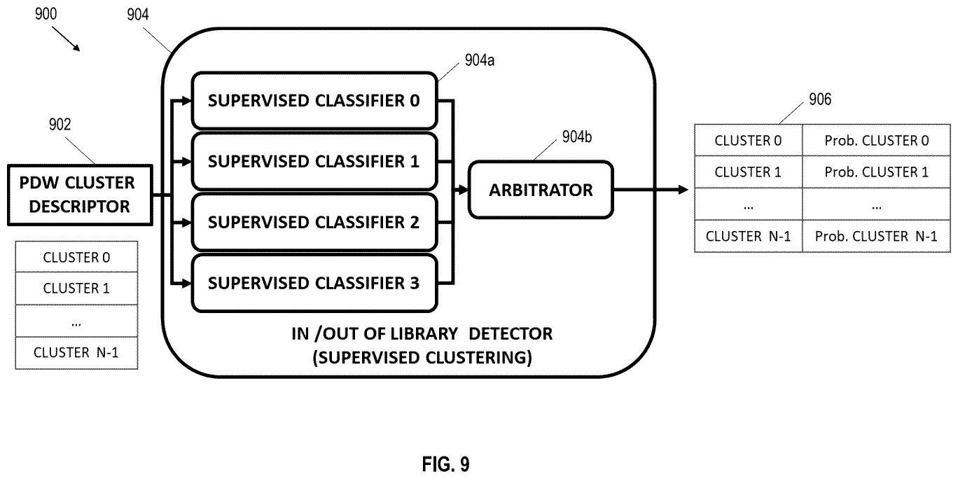

In another embodiment, an ensemble of supervised algorithms may be used. FIG. 9 illustrates an ensemble prediction in accordance with some aspects. The process 900 shown in FIG. 9 includes an IN/OUT OF LIBRARY DETECTOR 904 to which PDW cluster descriptors 902 are supplied. The IN/OUT OF LIBRARY DETECTOR 904 may use an ensemble method in which multiple independent supervised ML algorithms 904a (also referred to as supervised ML models) are used to derive an output 906 or make a prediction. An ensemble can be built with a combination of different models 904a such as those above random forest, SVM, Logistic regression etc. When different models 904a are used, the final decision is made based on a weighted combination of the outputs from the models 904a by an arbitrator 904b. In one embodiment, a majority voting of all the algorithms 904a in the ensemble is used to provide an in-library score. In another embodiment, a soft voting method that combines the output of algorithms 904a in the ensemble is used to determine the final score. The ensemble method may be used to mitigate errors and predictions in individual ML models that are adversely influenced by bias, variance, and noise.

The supervised ML algorithms 904a may be trained with a library of known and labeled threats. Out of all the received PDWs, supervised ML methods use intrinsic radar characteristics that are inherent properties or qualities that are fundamental to an object or a system. These intrinsic radar characteristics may include characteristics related to frequency, such as center frequency, pulse width, and pulse repetition pattern. Such traits may be inherent to the nature of the radar itself. To offer additional robustness, training data may be augmented and translated using different frequency offsets, variations of pulse width, and others.

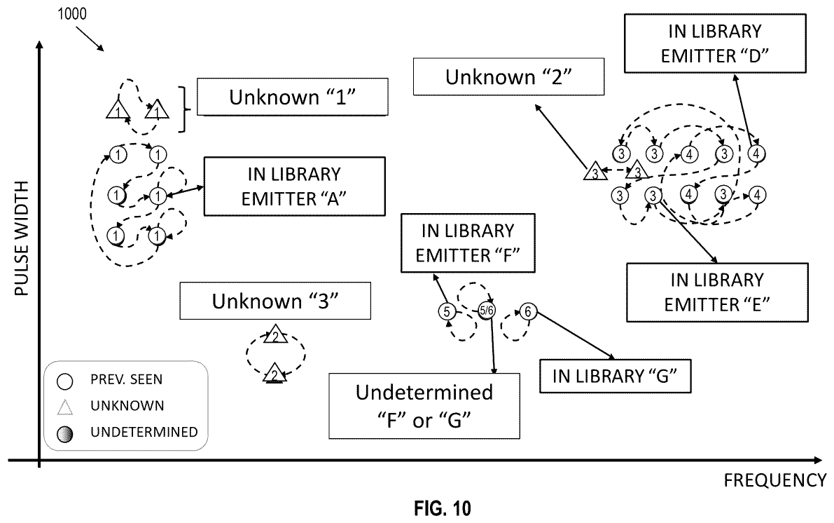

For the true emitter classes shown in the FIG. 4, a desired output of the IN/OUT OF LIBRARY DETECTOR 904 is shown in FIG. 10, which illustrates an IN/OUT OF LIBRARY DETECTOR output 1000 in accordance with some aspects. As can be seen in FIG. 10, some of the clusters are labeled as “UNKNOWN” since the likelihood of clusters belonging to classes in the training data is low. Similarly, an “UNDETERMINED” cluster is present that could belong to either Emitter “F” or “G” since no information in the training data can be used to determine who originated those pulses. To resolve this ambiguity, some of the extrinsic features in the PDW (e.g., Angle of Arrival, Amplitude, time information) may be used to resolve which emitter generated these pulses.

To support scenarios in which emitters exhibit behaviors that are different from the training data, engineering features have been developed that focus on the relative behavior of pulses within a cluster. For example, if Emitter A was observed in the training data at frequency F1 and F2, where AF=|F2−F1|, the relative frequency of Emitter A (i.e., the delta) may be used as a feature. This permits evaluation of clusters at different absolute frequencies (F3, F4) that have a delta frequency of (|F2−F1|=|F4−F3 by the supervised ML algorithm; the supervised ML algorithm may thus evaluate the probability that the pulses were generated by Emitter A.

The OOL tracker 406 shown in FIG. 4 may use additional pulse descriptor information that also includes extrinsic radar properties. Extrinsic characteristics are properties or qualities that are not inherently part of an object or system but are instead imposed or influenced by external factors or conditions. Examples of extrinsic pulse characteristics are signal amplitude, angle of arrival, time of pulse arrival, and others. These extrinsic pulse properties allow the tracking of signals that have not been observed in the past and are not part of the training library of signals. It also allows for the resolution of ambiguities for cases such as Emitters “F” and “G” in FIG. 4.

The output of the IN/OUT OF LIBRARY DETECTOR 404 may be supplied to either an OOL tracker 406 or an In Library tracker 408. In some cases, a majority of the PDWs that are analyzed by IN/OUT OF LIBRARY DETECTOR 404 may be categorized as OOL and the corresponding clusters provided to OOL tracker 406, resulting in low in-library score. There are multiple reasons that may result in a low in-library score. One reason may be that the observed features have never been seen before for any of the known threats (radar emitters): that is, a truly unknown emitter. Another reason is that a hidden or reserve mode of a known emitter has become active. Another reason may be that multiple in-library threats have been observed to radiate pulses with a similar value to the PDWs and there is no intrinsic information that can be used to disambiguate the emitter source. The OOL tracker 406 handles all these cases.

The information from the OOL tracker 406 may be merged with an In Library tracker 408 using a track merger 410. This may occur after a particular dwell has occurred and the PDWs are processed. As above, a dwell refers to the period of time during which a radar system focuses its attention on a specific area or target. During a dwell, when pulses from a single in-library radar with a unique angle of arrival are being detected followed by pulses from an unknown source with similar angle of arrival and signal amplitude properties, a prediction may be made that there is actually a single radar present with the latter pulses belonging to a reserve mode and the initial pulses belonging to an in-library mode. For these cases, the track merger 410 has the task of associating all pulses in a single track.

Radar reserve modes are configurations with parameters that a radar operator may use at critical times. These modes impact radar system survivability, countermeasure development, deception operations, and the effectiveness of electronic attack and information warfare activities in EW environments. A radar operating in a reserve mode is often identified as an “unknown” by traditional emitter ID algorithms. However, it is possible to associate pulses from a reserve and non-reserve mode by associating extrinsic PDW properties with some intrinsic properties.

The track merger 410 may use a track merge algorithm to analyze the unlabeled OOL tracks and correlate the unlabeled OOL tracks to known In Library tracks. For example, if a radar exhibits an interleaved mode at a new OOL frequency, it is probable that there is a temporal correlation between the OOL mode and the In Library mode. Emitter “A” in FIG. 5 falls into this category. Similarly for emitters “F” and “G”, there may not be sufficient information to determine the emitter class. The output probabilities determined by the supervised classification algorithm for the overlapping cluster in FIG. 5 is a 50% chance of class “F” or “G”. For such scenarios, additional extrinsic features based on timing information, amplitude or angle of arrival, among others, may be used to perform the final class determination.

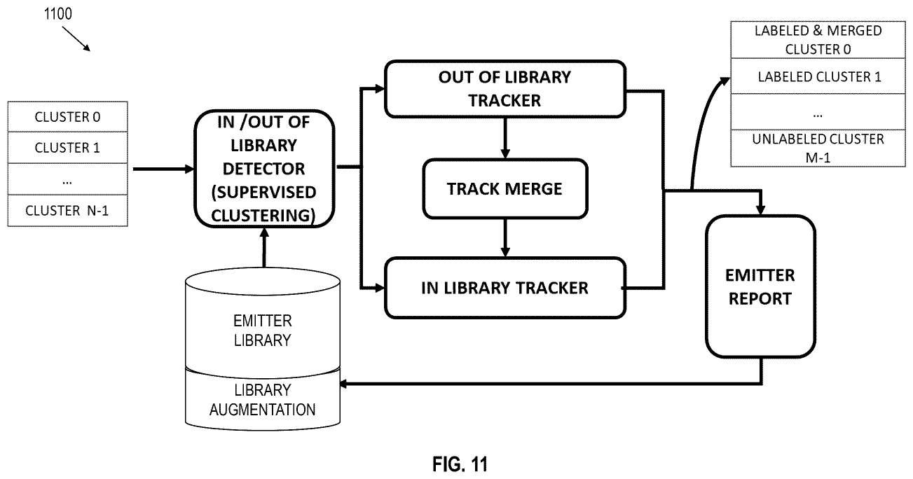

FIG. 11 illustrates an in and out of library detector process in accordance with some aspects. The process 1100 is replicated from FIG. 4, with specifics about the cluster provided to the input of the IN/OUT OF LIBRARY DETECTOR 404 and labeled cluster output from the trackers shown in more detail.

In addition to the TOA being correlated, the pulse amplitude may also have a similar correlation. Features based on TOA and/or pulse amplitude patterns may be used to determine whether OOL tracks are to be attributed to a known radar. The features may in some embodiments be processed by a decision tree classifier with a single output: the probability that the tracks should be merged by the track merger 410. In one embodiment, an interleaved temporal feature analysis may be used by the track merger 410 to determine track merges. The TOA profile of two clusters of pulses that are candidates for merging by the track merger 410 may be analyzed for a consistent ordering by an inverse exponential basis function.

Never-before seen radar modes may not operate at the same frequency or pulse width as known modes. The TOA approach can allow the association of clusters that have very different PDW properties. The TOAs may be correlated from an unknown cluster correlated with the TOAs from a cluster that was labeled as in-library by the IN/OUT OF LIBRARY DETECTOR 404. Such correlation may involve processing the relative time of arrival through an inverse exponential basis function, as shown in equation (1).

$$Δ Θ = {\sum }_{TOA 1} {\sum }_{TOA 2} Θ ( {t}_{i}^{1} - {t}_{j}^{2} ) \qquad ( 1 )$$

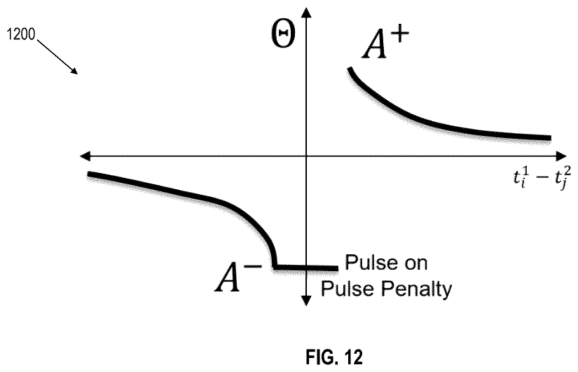

Under the condition that there is, on average, a consistent time ordering then ΔΘ>>0. If the relative times of arrival are uncorrelated then ΔΘ<<0 because |A⁻|>|A⁺|. An example of the basis function is shown below in the graph 1200 of FIG. 12, which illustrates a TOA Correlation Basis Function example in accordance with some aspects.

In another embodiment, a dwell switching temporal feature may be used by the track merger 410 to determine track merges. Such a feature may be triggered when there is a consistent timing interval between when one OOL track ends and another OOL track begins. In some embodiments, the algorithm may use the same interleaved temporal feature equation (1) but with altered variable definitions. The pulse width stored in a PDW may be used to determine the length of time that a track is active. The TOA in the PDW may indicate when a track begins.

In another embodiment, an amplitude matching feature is used by the track merger 410 to determine track merges. The performance of the OOL track labeler may be improved when amplitude is available, but in some embodiments use of the amplitude may be avoided. A quadratic model may be fit to the amplitude profile of both tracks, y₁(t) and y₂(t) as shown by equation (2).

$${y}_{1} ( t ) = {a}_{1} {t}^{2} + {b}_{1} t + {c}_{1} \qquad ( 2 )$$

$${y}_{2} ( t ) = {a}_{2} {t}^{2} + {b}_{2} t + {c}_{2}$$

The root mean square (RMS) error over time window T may be calculated between the two tracks as shown by equation (3).

$${E}_{rms} = \sqrt[2]{\frac{1}{{T}_{2} - {T}_{1}} {\int }_{{T}_{1}}^{{T}_{2}} {( {y}_{2} ( t ) - {y}_{1} ( t ) )}^{2} dt} \qquad ( 3 )$$

The polynomial fit may be substituted into the equation and Eᵣₘₛ solved for directly by manipulating the fitting coefficients (a, b, c) and time range.

The features previously mentioned may be consolidated into a vector and processed by a decision tree to determine the probability of association. Most associations may occur when the RMS power error is small, and TOA synchronization and edge projection values are a small positive number.

Thus, a set of 1024 PDWs stored in the PDW buffer 604a may be transformed into a cluster set of N<1024 clusters that group similar PDWs. As shown in FIGS. 4 and 11, the N clusters are supplied to supervised clustering algorithms of the IN/OUT OF LIBRARY DETECTOR 404. The result is a set of M<N clusters that may contain different categories of clusters of PDWs. One such category is a Labeled & Merged cluster of PDWs, which are the result of combining an initial set of in-library PDWs with PDWs that are initially labeled as unknown or OOL, but later merged. Emitter “A” in FIG. 5 falls into this category if clustered correctly. Some clusters only contain in-library PDWs and are labeled with the corresponding emitter ID. Emitters “D” and “E” in FIG. 5 fall into this category if clustered correctly. Never-before seen emitters, like emitters “B” and “C” in FIG. 5 may be clustered in separate unlabeled clusters. The architecture described may detect that emitters with the “B” and “C” properties have never been seen before, but also that emitters “B” and “C” are different from each other and should be tracked separately.

Modern multi-function radars may exhibit new or unusual modes that may not be expected prior to the mission. For example, a search radar may change its waveform to an acquisition waveform that was not previously observed. Current generation threat radars may also use new frequencies outside the range of what was thought possible while performing the same function. This type of waveform agility change can be particularly challenging to track. Most countermeasures for radar, commonly known as EA jamming techniques, match the carrier frequency of the radar of interest to adjust the signal-to-noise ratio (SNR) of the matched filter of the threat radar. Even when using other non-noise based jamming techniques, such as a false-plot technique, the waveform transmitted as a result of the process shown in FIG. 4 is to be close in frequency to be categorized as the return signal at the threat emitter.

Proper attribution of the frequency to the threat radar is allows jamming of the threat radar; without proper attribution, the actual emitter frequency remains unjammed, causing the counter radar mission to fail. Estimating the parameters correctly and creating the appropriate labels in an unsupervised way may also generate new intelligence information that can be shared, e.g., among multiple aircraft, and analyzed after the mission. The OOL tracker 406 and In Library tracker 408 provides results in an emitter report 412. The emitter report may be supplied to an emitter library 414 for augmentation 414a as well as to an EA module for preparing countermeasures for transmission. Enabling augmentation 414a of the emitter library 414 to reflect changes in the EW environment is one result of labeling the OOL tracks. Similar to an optimization problem, the IN/OUT OF LIBRARY DETECTOR 404 may use the information of the emitter library 414 to result in an initial prediction of the optimum solution. Using information available via library augmentation may lead to the global optimum.

The feedback loop created by online training of the classifiers may improve the overall system performance by having an updated library that accurately represents the actual EW environment. Similar to a feedback control system, the inclusion of feedback via the emitter library 414 may allow the system to provide faster reactions to stimulus. However, as such feedback may also drive the system to instability under certain conditions, the modification of the system to a new optimum may be relatively slow, e.g., multiple dwell times may be used prior to providing the feedback to the emitter library 414. Accordingly, multi-dwell tracking, also known as multi-hypothesis tracking, used for tracking targets over multiple radar dwells or observation intervals may be used to support multiple time scales in the system 400 of FIG. 4. However, if faster updates are preferred, the emitter identification system 400 may operate over a single dwell collection rather than the multi-dwell embodiment that tracks and associates multiples sets of PDWs and clusters across multiple dwells.

For clusters initially labeled as OUT OF LIBRARY and later merged and associated with in-Library clusters, the initial data library may be updated and include the merged clusters with new in-library labels. This association of reserve modes with previously seen emitters allows performance to be maintained even when unexpected signals appear in the EW environment.

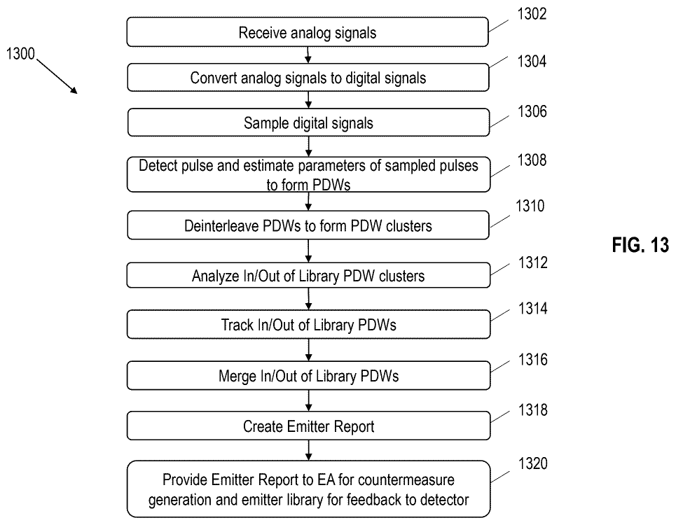

FIG. 13 illustrates a method of emitter identification and tracking in accordance with some aspects. In some embodiments, the electronic device(s), network(s), system(s), chip(s) or component(s), or portions or implementations thereof may be configured to perform one or more processes, techniques, or methods as described herein, or portions thereof. Only some of the operations are shown in the process 1300 of FIG. 13; other operations may be present but are not shown.

At operation 1302, analog RF signals are received by antennas of an emitter identification and tracking system.

At operation 1304, the analog RF signals are converted to digital signals.

At operation 1306, the digital signals are sampled.

At operation 1308, the sampled digital signals are processed to determine the presence of a pulse. In addition, the parameters of the pulses such as frequency, phase, amplitude, and modulation type are estimated. After the pulses are detected and parameters extracted, PDWs are formed.

At operation 1310, the PDWs are deinterleaved using one or more unsupervised ML algorithms to form PDW clusters defined by PDW cluster descriptors.

At operation 1312, the PDW cluster descriptors supplied to an In/Out of Library detector to analyze the PDWs. One or more supervised ML algorithms may be used, with an arbitrator used to determine a final categorization. Both intrinsic and extrinsic features in the PDW may be used to determine whether a PDW cluster is in library or out of library (associated with a known or unknown emitter).

At operation 1314, both in library and out of library PDW clusters are tracked and then merged at operation 1316. One or more dwell times may be used during the merge.

At operation 1318, an emitter report is created that indicates which emitters are present as well as characteristics of the PDWs from the emitters.

At operation 1320, the emitter report is supplied to EA circuitry used to determine countermeasures based on the emitter report. The countermeasures are then generated and transmitted to counter enemy emitters without affecting neutral or friendly emitters. In addition, the emitter report is used to update an emitter library, which is used by the supervised ML algorithms of the In/Out of Library detector for PDW clustering in the next dwell.

### EXAMPLES

Example 1 is a system for emitter identification and tracking in an electronic warfare scenario, the system comprising: an antenna array configured to receive signals from radio frequency (RF) emitters; processing circuitry configured to: convert the signals received from the RF emitters into digital signals; determine, from the digital signals, pulse descriptor words (PDWs) that describe characteristics of the digital signals, classify the PDWs using a combination of unsupervised machine learning and supervised machine learning to form classification results that indicate whether the PDWs correspond to one of a known emitter and an unknown emitter; and update an emitter library of emitter profiles based on the classification results; and a memory configured to store the PDWs.

In Example 2, the subject matter of Example 1 includes, wherein the processing circuitry is configured to apply deinterleaving to the PDWs using the unsupervised machine learning to form PDW clusters of PDWs based on a combination of intrinsic and extrinsic emitter characteristics described by the PDWs.

In Example 3, the subject matter of Example 2 includes, wherein the intrinsic emitter characteristics or emitter features described by the PDWs comprise at least one of Carrier Frequency (Fc), Pulse Width (PW), pulse repetition interval (PRI), signal bandwidth (BW), or a feature available in training data used to train the unsupervised machine learning and available to the system.

In Example 4, the subject matter of Examples 2-3 includes, wherein the extrinsic characteristics comprise at least one of Pulse Amplitude (PA), Time of Arrival (TOA), Angle of Arrival (AOA), or Pulse Repetition Interval (PRI).

In Example 5, the subject matter of Examples 1-4 includes, wherein the unsupervised machine learning includes forming PDW clusters from the PDWs using a density-based spatial clustering of applications with noise (DBSCAN), a number of PDW clusters being less than a number of PDWs.

In Example 6, the subject matter of Examples 1-5 includes, wherein the supervised machine learning includes use of at least one of a Bayesian Inference Engine or an ensemble learning algorithm, the ensemble learning algorithm including at least one of Random Forest, Extra Trees, Support Vector Machines (SVMs), Gradient Boosting, Adaptive Boosting, Decision Trees, Gradient Boosting Machines or another tree-based classification algorithm to classify the PDWs based on features of known emitters.

In Example 7, the subject matter of Examples 1-6 includes, wherein: the unsupervised machine learning includes forming PDW clusters from the PDWs, and the supervised machine learning includes a plurality of supervised classifiers and an arbitrator, each of the supervised classifiers configured to use the PDW clusters to generate a prediction of an emitter used to generate the PDWs, the arbitrator configured to weight the predictions from the supervised classifiers to generate a final decision of the emitter used to generate the PDWs.

In Example 8, the subject matter of Example 7 includes, wherein the supervised machine learning is configured to limit use of intrinsic and extrinsic emitter characteristics described by the PDWs to the intrinsic emitter characteristics described by the PDWs.

In Example 9, the subject matter of Example 8 includes, wherein the supervised machine learning is configured to generate the final decision by matching the intrinsic emitter characteristics described by the PDWs to an emitter identity indicated in training data for the supervised machine learning.

In Example 10, the subject matter of Examples 1-9 includes, wherein: the unsupervised machine learning includes forming PDW clusters from the PDWs, and the supervised machine is configured to use relative behavior of the PDWs within each cluster to determine whether different PDWs within one of the PDW clusters were generated by an identical emitter.

In Example 11, the subject matter of Examples 1-10 includes, wherein the processing circuitry is further configured to: track in library PDWs from a known first emitter and out of library PDWs from an unknown first emitter; and merge the in library PDWs from the known first emitter with the out of library PDWs from the unknown first emitter in response to a determination that the known first emitter and the unknown first emitter are an identical emitter based on extrinsic emitter characteristics of the in library PDWs and the out of library PDWs.

In Example 12, the subject matter of Examples 1-11 includes, wherein the processing circuitry is configured to: generate an emitter report that includes information on a type, location, and behavior of tracked emitters, and use the emitter report to update the emitter library to an updated emitter library and generate electronic attack strategies to be pursued.

In Example 13, the subject matter of Example 12 includes, wherein: at least one of the unsupervised machine learning or supervised machine learning is re-trained periodically using the updated emitter library or a subset of features based on new information obtained from the PDWs, and the processing circuitry is configured to use a Mission Data File Free (MDF-Free) approach in which identification and tracking do not rely exclusively on a pre-existing database of emitter characteristics but are based on learned characteristics from real-time data.

Example 14 is a method of identifying sources of radio frequency (RF) signals, the method comprising: receiving the signals from the sources; digitizing the signals to form digital signals; detecting the digital signals, extracting pulse parameters of the digital signals, and generating pulse descriptor words (PDWs) based on the pulse parameters; deinterleaving the PDWs using unsupervised machine learning algorithms; selecting a representative set of PDWs from a cluster of PDWs that have been deinterleaved; determining a likelihood that the representative set of PDWs belong to a known emitter present in an emitter library; and updating the emitter library with clusters of PDWs selected for a track merge.

In Example 15, the subject matter of Example 14 includes, wherein the supervised machine learning algorithm is implemented by an ensemble of supervised machine learning algorithms and an arbitrator function that combines an output from each of the ensemble of supervised machine learning algorithms.

In Example 16, the subject matter of Example 15 includes, determining, for the cluster of PDWs, a probability of belonging to a known emitter present in training data for the supervised machine learning algorithms; and assigning the cluster of PDWs to a group selected from: within a training library for high probability clusters, within the training library but with insufficient initial information to determine which class within the emitter library for medium or moderate probability PDW clusters, and out of the training library for low probability clusters.

In Example 17, the subject matter of Examples 14-16 includes, merging “OUT OF LIBRARY” tracks that correspond to reserve or unseen modes of “IN LIBRARY” emitters with “IN LIBRARY” tracks using at least one of: temporal feature analysis based on a time of arrival comparison of PDWs in an out-of-library cluster with PDWs in a tracker with PDWs from known emitters, temporal feature analysis based on a time of arrival comparison of PDWs using multiple dwells, or pulse amplitude matching between an out-of-library cluster with amplitudes of PDWs in a cluster that groups PDWS from known emitters.

In Example 18, the subject matter of Examples 14-17 includes, merging “OUT OF LIBRARY” tracks that correspond to reserve modes of “IN LIBRARY” emitters with “IN LIBRARY” tracks using a combination of multiple extrinsic PDW features selected from a group that includes temporal feature analysis, pulse amplitude matching, and angle of arrival or direction matching between an out-of-library cluster with amplitudes of PDWs in a cluster that groups PDWs from known emitters.

Example 19 is a non-transitory computer-readable medium storing instructions that, when executed by a processor in an electronic warfare environment, cause the processor to: convert received radio frequency (RF) signals into digital signals and extract, from the digital signals, pulse descriptor words (PDWs) that describe characteristics of the received RF signals, classify the PDWs using a combination of a supervised machine learning technique and an unsupervised machine learning technique to determine whether the PDWs correspond to known emitters or whether the PDWs correspond to unknown emitters; update a library of emitter profiles to include, identified emitters based on classification results; determine whether to track the identified emitters based on the updated library; and track the identified emitters in response to a determination to track the identified emitters.

In Example 20, the subject matter of Example 19 includes, wherein the instructions, when executed, cause the processor to update the library by: incorporating new emitter profiles into the library based on PDWs classified as originating from unknown emitters, and refining existing emitter profiles in the library based on new information obtained from PDWs classified as originating from known emitters.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although embodiments have been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. For example, the term “a processor” configured to carry out specific operations includes both a single processor configured to carry out all of the operations as well as multiple processors individually configured to carry out some or all of the operations (which may overlap) such that the combination of processors carry out all of the operations. Note that the term “about x” and similar terms (e.g., substantially) as used herein may be understood to be within 10% of x or otherwise within a range known to one of skill in the art to be within tolerance of the quantity or quality described unless indicated otherwise.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A system for emitter identification and tracking in an electronic warfare scenario, the system comprising:
an antenna array configured to receive signals from radio frequency (RF) emitters;
processing circuitry configured to:
convert the signals received from the RF emitters into digital signals;
determine, from the digital signals, pulse descriptor words (PDWs) that describe characteristics of the digital signals,
classify the PDWs using a combination of unsupervised machine learning and supervised machine learning to form classification results that indicate whether the PDWs correspond to one of a known emitter and an unknown emitter; and
update an emitter library of emitter profiles based on the classification results; and a memory configured to store the PDWs.

2. The system of claim 1, wherein the processing circuitry is configured to apply deinterleaving to the PDWs using the unsupervised machine learning to form PDW clusters of PDWs based on a combination of intrinsic and extrinsic emitter characteristics described by the PDWs.

3. The system of claim 2, wherein the intrinsic emitter characteristics or emitter features described by the PDWs comprise at least one of Carrier Frequency (Fc), Pulse Width (PW), pulse repetition interval (PRI), signal bandwidth (BW), or a feature available in training data used to train the unsupervised machine learning and available to the system.

4. The system of claim 2, wherein the extrinsic characteristics comprise at least one of Pulse Amplitude (PA), Time of Arrival (TOA), Angle of Arrival (AOA).

5. The system of claim 1, wherein the unsupervised machine learning includes forming PDW clusters from the PDWs using a density-based spatial clustering of applications with noise (DBSCAN), a number of PDW clusters being less than a number of PDWs.

6. The system of claim 1, wherein the supervised machine learning includes use of at least one of a Bayesian Inference Engine or an ensemble learning algorithm, the ensemble learning algorithm including at least one of Random Forest, Extra Trees, Support Vector Machines (SVMs), Gradient Boosting, Adaptive Boosting, Decision Trees, Gradient Boosting Machines or another tree-based classification algorithm to classify the PDWs based on features of known emitters.

7. The system of claim 1, wherein:
the unsupervised machine learning includes forming PDW clusters from the PDWs, and
the supervised machine learning includes a plurality of supervised classifiers and an arbitrator, each of the supervised classifiers configured to use the PDW clusters to generate a prediction of an emitter used to generate the PDWs, the arbitrator configured to weight the predictions from the supervised classifiers to generate a final decision of the emitter used to generate the PDWs.

8. The system of claim 7, wherein the supervised machine learning is configured to limit use of intrinsic and extrinsic emitter characteristics described by the PDWs to the intrinsic emitter characteristics described by the PDWs.

9. The system of claim 8, wherein the supervised machine learning is configured to generate the final decision by matching the intrinsic emitter characteristics described by the PDWs to an emitter identity indicated in training data for the supervised machine learning.

10. The system of claim 1, wherein:
the unsupervised machine learning includes forming PDW clusters from the PDWs, and
the supervised machine is configured to use relative behavior of the PDWs within each cluster to determine whether different PDWs within one of the PDW clusters were generated by an identical emitter.

11. The system of claim 1, wherein the processing circuitry is further configured to:
track in library PDWs from a known first emitter and out of library PDWs from an unknown first emitter; and
merge the in library PDWs from the known first emitter with the out of library PDWs from the unknown first emitter in response to a determination that the known first emitter and the unknown first emitter are an identical emitter based on extrinsic emitter characteristics of the in library PDWs and the out of library PDWs.

12. The system of claim 1, wherein the processing circuitry is configured to:
generate an emitter report that includes information on a type, location, and behavior of tracked emitters, and
use the emitter report to update the emitter library to an updated emitter library and generate electronic attack strategies to be pursued.

13. The system of claim 12, wherein:
at least one of the unsupervised machine learning or supervised machine learning is re-trained periodically using the updated emitter library or a subset of features based on new information obtained from the PDWs, and
the processing circuitry is configured to use a Mission Data File Free (MDF-Free) approach in which identification and tracking do not rely exclusively on a pre-existing database of emitter characteristics but are based on learned characteristics from real-time data.

14. A method of identifying sources of radio frequency (RF) signals, the method comprising:
receiving the signals from the sources;
digitizing the signals to form digital signals;
detecting the digital signals, extracting pulse parameters of the digital signals, and generating pulse descriptor words (PDWs) based on the pulse parameters;
deinterleaving the PDWs using unsupervised machine learning algorithms;
selecting a representative set of PDWs from a cluster of PDWs that have been deinterleaved;
determining a likelihood that the representative set of PDWs belong to a known emitter present in an emitter library; and
updating the emitter library with clusters of PDWs selected for a track merge.

15. The method of claim 14, wherein the supervised machine learning algorithm is implemented by an ensemble of supervised machine learning algorithms and an arbitrator function that combines an output from each of the ensemble of supervised machine learning algorithms.

16. The method of claim 15, further comprising:
determining, for the cluster of PDWs, a probability of belonging to a known emitter present in training data for the supervised machine learning algorithms; and
assigning the cluster of PDWs to a group selected from:
within a training library for high probability clusters,
within the training library but with insufficient initial information to determine which class within the emitter library for medium or moderate probability PDW clusters, and
out of the training library for low probability clusters.

17. The method of claim 14, further comprising merging “OUT OF LIBRARY” tracks that correspond to reserve or unseen modes of “IN LIBRARY” emitters with “IN LIBRARY” tracks using at least one of:
temporal feature analysis based on a time of arrival comparison of PDWs in an out-of-library cluster with PDWs in a tracker with PDWs from known emitters,
temporal feature analysis based on a time of arrival comparison of PDWs using multiple dwells, or
pulse amplitude matching between an out-of-library cluster with amplitudes of PDWs in a cluster that groups PDWS from known emitters.

18. The method of claim 14, further comprising merging “OUT OF LIBRARY” tracks that correspond to reserve modes of “IN LIBRARY” emitters with “IN LIBRARY” tracks using a combination of multiple extrinsic PDW features selected from a group that includes temporal feature analysis, pulse amplitude matching, and angle of arrival or direction matching between an out-of-library cluster with amplitudes of PDWs in a cluster that groups PDWs from known emitters.

19. A non-transitory computer-readable medium storing instructions that, when executed by a processor in an electronic warfare environment, cause the processor to:
convert received radio frequency (RF) signals into digital signals and extract, from the digital signals, pulse descriptor words (PDWs) that describe characteristics of the received RF signals,
classify the PDWs using a combination of a supervised machine learning technique and an unsupervised machine learning technique to determine whether the PDWs correspond to known emitters or whether the PDWs correspond to unknown emitters;
update a library of emitter profiles to include identified emitters based on classification results;
determine whether to track the identified emitters based on the updated library; and
track the identified emitters in response to a determination to track the identified emitters.

20. The non-transitory computer-readable medium of claim 19, wherein the instructions, when executed, cause the processor to update the library by:
incorporating new emitter profiles into the library based on PDWs classified as originating from unknown emitters, and
refining existing emitter profiles in the library based on new information obtained from PDWs classified as originating from known emitters.
